(19) United States
(12) Patent Application Publication
(10) Pub. No.: US 2010/0285834 A1
(43) Pub. Date: Nov. 11, 2010

(54) REMOTE ACTIVATION CAPTURE

(75) Inventor: James A. Hutchison, IV, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/772,855

(22) Filed: May 3, 2010

Related U.S. Application Data
(60) Provisional application No. 61/175,727, filed on May 5, 2009.

(51) Int. Cl. H04W 88/02

(52) U.S. Cl. 455/550.1

(57) ABSTRACT

A method and system are provided for remotely collecting activation information for one or more components, modules, and/or elements of a wireless device. The wireless device may detect its activation with a service provider to be able to operate or communicate over a network. Once activated for service, the wireless device may be adapted to collect information about which of its components, modules, and/or elements have been activated. Such activation information may be reported to a remote activation server that tracks such collection from a plurality of wireless devices. The collection of information pertaining to activation of specific components, modules, and/or elements of a wireless device may be used to pay royalties to the manufacturer or vendor of the components, modules, and/or elements. The collection of activation information may also be used to determine which features are being activated in the wireless device.

### CLAIM OF PRIORITY UNDER 35 U.S.C. §119

The present Application for Patent claims priority to U.S. Provisional Application No. 61/175,727 entitled “Remote Activation Capture”, filed May 5, 2009, and assigned to the assignee hereof and hereby expressly incorporated by reference herein.

### FIELD

One feature relates to communication systems, and more particularly, to an improved method for collecting information about activation of components, modules, and/or elements of a wireless device, separate from wireless device activation data collection by the service provider.

### BACKGROUND

As the market for wireless devices with integrated hardware and/or software components or elements continues to grow, there is a growing interest in enabling business models where some of the revenue flows to vendors and/or suppliers (e.g., secondary providers) of the integrated hardware and/or software components. For example, these business models can include additional revenue flowing to providers of a modem or other components or modules of the wireless device. Such additional revenues may be based on a post distribution triggering event, such as when a particular component or feature is activated and/or used. For instance, a Wireless Service Provider (WSP) may collect Wireless Service Activation (WSA) information and reports such activation to the secondary provider(s) who, for example, may be paid a royalty based on such activation. This collecting/reporting activity is a burden on the WSP (e.g., wireless service provider or carrier). Furthermore, placing the burden of reporting solely on the WSP raises some concerns as well for the secondary provider(s) who rely solely on the WSP to accurately report the activation and/or possibly make additional payments based on such activation.

Wireless devices distributed in the open market can be associated with a variety of WSP's under a variety of service models. The means of activating service on wireless devices are diverse and often unique to each WSP. In some cases, activation is accomplished utilizing an application running on a connected computer. In other cases, a removable Subscriber Identity Module (SIM) is installed in the device. In yet other cases, an embedded application, such as Open Mobile Alliance (OMA)/Device Management (DM), manages the activation. WSA generally occurs apart from the service personnel of the WSP; this confounds most means of physical accounting of this information. Likewise, some of the wireless devices are typically sold through channels (e.g., mail ordered, etc.) other than those of a particular WSP, where the wireless device transaction occurs well in advance of the WSA.

In support of billing the WSP in association with WSA, the billing party may need to provide sufficient indication that the WSA was associated with a particular device to be paid for. False counts and double-counts are clearly undesirable in such a system. Lost counts, from devices which were not counted after performing WSA, are also undesirable.

Most wireless calls bear a cost to the caller. It is expected that consumers will continue to be cost-conscious and thus not welcome any meaningful cost burden associated with tracking the WSA. This is problematic for communicating WSA information back to the providers. For “free” communications, some WSP allow for toll-free numbers and others may come to an arrangement to allow the WSA network activity to be “free” to the consumer, or as a component of the service agreement. The consumer and/or communication connectivity may inadvertently interrupt this communication, necessitating re-attempts.

Therefore, a system and method are needed that reduces the processing burden on a WSP, improves “burden of trust” for reporting, expands opportunities for data mining related to activation, provides a means for non-repudiation of activations and/or does not require active participation of the WSP. Such system would preferably capture activation information for one or more components, modules, and/or elements (e.g., integrated hardware and software) of a wireless device in a manner that is independent of the wireless service provider, i.e. separate from the wireless device activation data collection by the service provider

### SUMMARY

One feature provides a system and method for collecting information about activation of components, modules, and/or elements of a wireless device, separate from wireless device activation data collection by the service provider. By separately collecting this information, secondary providers (e.g., manufacturers or vendors of integrated hardware or software for a wireless device) may be directly notified when their modules, components and/or elements are activated and provide the ability to directly collect the activation information for modules, components, and/or elements of a wireless device, while removing the burden from the service provider or carrier of the wireless device. The information may be collected upon activation of the modules, components, and/or elements of the wireless device, prior to use of the modules, components, and/or elements.

In one example, a system for capturing activation information of one or more modules, components, and/or elements of a wireless device is disclosed. In the system, the wireless device may be programmed to detect and securely communicate wireless service activation (WSA) events to a remote activation server, where WSA events may include the activation of one or more components, elements and/or modules in the wireless device. The remote activation capture described herein, may avoid having the service provider or communication carrier collect and report activation of the components, modules and/or elements to the manufacturer or vendors. Such activation system may, for example, allow the wireless device manufacturer to collect fees (royalties) according to the communication features being used by the wireless device.

Once a WSA event has been detected, the wireless device may determine the significance of the WSA event. That is, the wireless device may determine if the WSA event is to be reported to the remote activation server. If it is determined that the WSA event is to be reported, an appropriate communication means for communicating the event may be selected and a mutually-authenticated secure transaction with the remote activation server may be performed. Authentication may occur by utilizing public-key cryptography so that message transactions may be mutually authenticated.

When reporting the event, the wireless device may initiate a call to a remote activation server, where such call includes a message with WSA event information, i.e. activation data or information about one or more components, modules and/or elements of the wireless device that has been activated. The remote activation server may tally the activation request (e.g., identify which component, module, and/or element is being activated) and may send an activation confirmation/acknowledgement to the wireless device. The activation message and/or confirmation may be secured by use of public/private key pairs and message authentication and/or integrity (e.g., using hash functions).

The information received from the wireless device about the activation of one or more components, modules, and/or elements may be utilized for data mining. For example, such information may be useful to manufacturers of the wireless device or the modules, components, and/or elements in ascertaining how the wireless device is being used and which features are most/least popular or useful. Additionally, the activation message may include location information (e.g., from a GPS) for the wireless device, thereby indicating where the wireless devices, as well as the components, elements and/or modules, are being activated and providing a geographical distribution of users.

### BRIEF DESCRIPTION OF THE DRAWINGS

Various features, nature and advantages may become apparent from the detailed description set forth below when taken in conjunction with the drawings in which like reference characters identify correspondingly throughout.

FIG. 1 illustrates a wireless network communication system in accordance with an aspect.

FIG. 2 (comprising FIGS. 2A and 2B) illustrates a functional block diagram of an activation capture system according to one example.

FIG. 3 illustrates a method for service activation of a wireless device (e.g., wireless communication device), according to one example.

FIG. 4 illustrates a block diagram of an internal structure of a wireless device of an activation capture system according to one example.

FIG. 5 illustrates an example of the operation of the wireless device.

FIG. 6 illustrates a block diagram of an internal structure of a remote activation server of an activation capture system according to one example.

FIG. 7 illustrates an example of the operation of the remote activation server.

FIG. 8 is a flow diagram illustrating the operation of a wireless communication system in which the collection of information about activation of components, modules, and/or elements of a wireless device is separate from wireless device activation data collection by a service provider.

FIG. 9 illustrates an example of a method for tracking activation of components of a wireless device.

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams, or not be shown at all, in order not to obscure the embodiments in unnecessary detail. In other instances, well-known circuits, structures and techniques may not be shown in detail in order not to obscure the embodiments.

### Overview

One feature provides a way to allow secondary providers (e.g., manufacturers or vendors of integrated hardware or software for a wireless device) to directly collect activation information (or data) for modules, components, and/or elements of a wireless device, while removing the burden from the service provider or carrier of the wireless device. The information may be collected upon activation of the modules, components, and/or elements of the wireless device, prior to use of the modules, components, and/or elements. Such remote activation capture as described herein may enable business models based on deferred compensation by capturing activations of wireless devices (and/or components therein) more reliably and without direct involvement by the service provider (e.g., wireless service provider or carrier) of the wireless device. Note that the collection of information from the activation of the modules, components, and/or elements of the wireless device may occur at a time separate or different from the time of the activation of wireless device. That is, while activation of the wireless device may occur, for example, at the point-of-sale, activation of some modules, components, and/or elements may be deferred until they are actually invoked or requested by the user. Therefore, such subsequent activation may occur subsequent to wireless device activation, e.g., remote from the point-of-sale. Additionally, the collection of information may occur concurrent with the one or more components, elements and/or modules being activated.

According to one example, a system for capturing activation of a wireless modem is disclosed, where the wireless modem in a wireless device may be programmed to detect and securely communicate WSA events, where WSA events may include activation of one or more components, modules and/or elements of a wireless device. The wireless modem may determine the significance of an event, an appropriate communication means for communicating the event, and perform a mutually-authenticated secure transaction with a remote activation server. Such activation system may, for example, allow the modem manufacturer to collect fees (royalties) according to the communication features being used by the wireless modem. For instance, if a user seeks to activate certain communication capabilities of the wireless modem that were not included in an original activation of the wireless device, then at the occurrence of such triggering event, the wireless device may notify the remote activation server that such capabilities are being activated. Such remote activation server may be owned, for example, by the wireless modem manufacturer, thereby allowing the wireless modem manufacturer to directly track and/or collect payment for such subsequent activations of additional capabilities and/or features.

According to yet another example, the activation capture system may provide a high-availability secure client-server architecture which allows: (1) the utilization of a voice-based data modem to capture activation information of the wireless device (and/or components therein) anywhere; (2) creation of a reliable activation information ledger based on secure transactions; and/or (3) data mining options for additional information relevant at activation. If available, a packet data network communication means could also be utilized as an option to a voice-based data modem communication means.

### Exemplary Network Environment

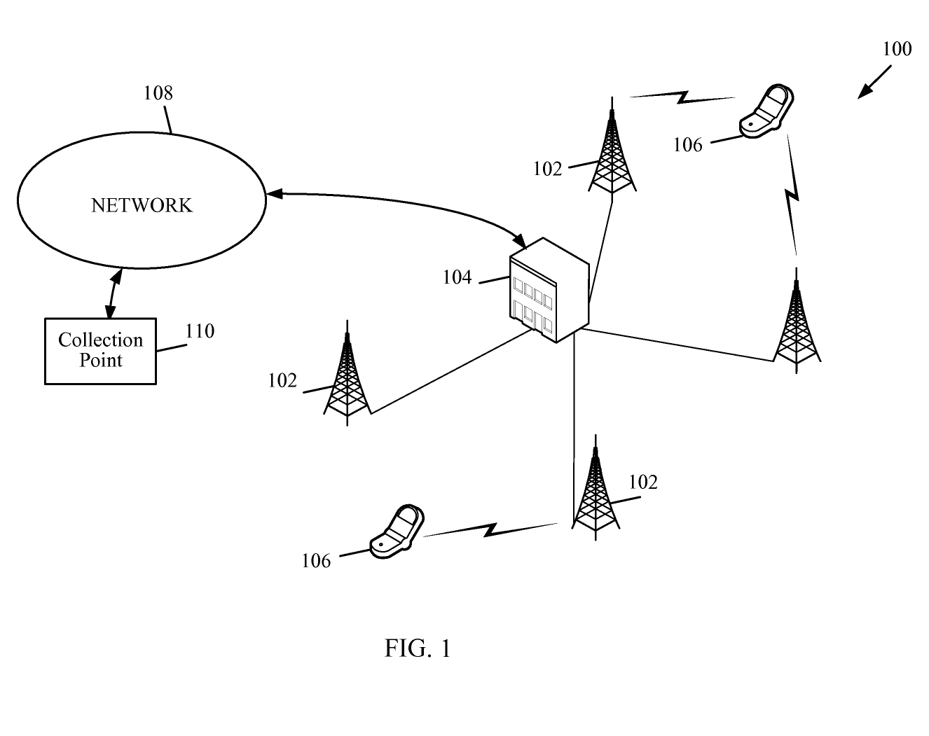

FIG. 1 illustrates a wireless network communication system 100 in accordance with an aspect. The system 100 can include one or more base transceiver stations 102 located in one or more cells that receive, transmit, repeat, etc., wireless communication signals to each other and/or to one or more wireless communication devices 106. Each base transceiver station 102 can include a transmitter chain and a receiver chain, each of which can in turn include a plurality of components associated with signal transmission and reception (e.g., processors, modulators, multiplexers, demodulators, demultiplexers, antennas, etc.), as will be appreciated by one skilled in the art. The transceiver stations 102 may be interconnected by one or more network entities 104, such as a server, controller, and/or gateway equipment.

Wireless devices 106 can be, for example, client terminals, subscriber devices, wireless communication devices, laptop computers, netbooks, mobile computing device, personal digital assistants, mobile phones, smart phones, cellular phones, mobile content storage and playback devices, global positioning systems, satellite radios, and/or any other suitable device for communicating over a wireless network 108. The wireless devices 106 can be employed in conjunction with various features and/or aspects described herein in order to facilitate collecting and reporting information about activation of the wireless devices or individual modules, components, and/or elements therein.

The system 100 may be communicatively coupled to one or more network entities 104 that allow it to communicate with a collection point 110, such as a remote activation server. Note that in other examples, the collection point 110 may be co-located with the network entities 104. The collection point 110 may be separate and/or distinct from the service provider and may be used for separate or subsequent activation events, e.g., after the initial activation of the wireless device by the service provider.

According to one feature, a wireless device 106 may include a wireless modem programmed to detect and/or securely communicate WSA events, by determining the significance of an event, selecting an appropriate communication means, and then performing a mutually-authenticated secure transaction with the collection point 110 operated for the benefit of such collecting WSA information. If unsuccessful, or if a new WSA event occurs, the wireless device 106 may re-attempt the communication. When successful, or at a point deemed as excessive (count/time/date/notification versus policy), the wireless device 106 may halt communication of the WSA event information.

The wireless device 106 may be adapted to select an appropriate communication means (e.g., voice or data channel or modem). One such means is a voice-band modem in the wireless device 106 which communicates over a voice call (or voice channel) to a voice-band modem associated with the collection point 110. Such voice call could utilize a pre-programmed toll-free number to direct the costs away from the caller. An alternative means is a packet-switched or circuit-switched data connection utilizing a data modem in the wireless device 106 and a network interface in the collection point 110.

A secure and authenticated transaction may be accomplished by provisioning a wireless modem in the wireless device 106 for authenticated transactions and making such encryption information available to the collection point 110 for sending and receiving authenticated secure transactions. The transactions may be signed with a cryptographic hash and encrypted using a cryptographic function. For the transaction, the wireless modem in the wireless device 106 may have unique identification information which it utilizes in the implementation of wireless communications on wireless networks. A cryptographic public-key is another type of unique identifier that may be utilized. A unique identifier programmed into the device may be utilized in determining which unique device participated in the WSA. Unique identifiers for the wireless device include an electronic serial number (ESN), Mobile Equipment Identifier (MEID), and/or International Mobile Equipment Identity (IMEI). The knowable uniqueness of this information and the authenticated transaction are used as one or more means of non-repudiation.

In the WSA event, there can be an interest in acquiring additional information, beyond unique identification of the wireless device or components/elements/modules therein, as observed by the wireless device. Information such as one or more of: WSP name (broadcast, PUZL, SIM card), network equipment ID (e.g., Mobile Network Code—MNC, SID, Network Identifier—NID, public land mobile network—PLMN, Base Station Identifier—BSID, etc.) observed by the wireless device, geographic location (lat/longitude, MCC, etc.), time-of-day (local, UTC, etc.), means of activation (over-the-air service provisioning—OTASP, IOTA, OMA/DM, SIM card, etc.), or type of activation (service plan, pre-pay, open-access, etc.).

Such system is strengthened by a secure means of storing and utilizing cryptographic keys and algorithms for the mutually-authenticated secure transactions. One, or more, of physical and computational security are well known in the art.

### Exemplary Remote Activation System

A wireless device may be placed in use or activated by a service provider or communication carrier. That is, after a wireless device is sold or deployed to a user, service with a service provider (e.g., wireless communication carrier) is activated for the wireless device.

However, in addition to such “activation” with the service provider or communication carrier, a process for remote activation capture may be performed. Such remote activation capture may allow manufacturers or vendors of components, modules and/or elements included in the wireless device (i.e., modem/hardware manufacturers, software vendors, etc.) to be directly notified when their module, component and/or element is activated. This remote activation capture process may be performed independent of (i.e. separate from), or in conjunction with, any “activation” performed with a service provider or communication carrier for the wireless device.

According to one example, remote capture (e.g., collection and/or reporting) of activation events, i.e. wireless service activation (WSA) events, for one or more components, modules, and/or elements of a wireless device may be performed utilizing a voice-based data modem over a voice channel or connection. In some approaches, device or service activation may be performed over a packet-data connection. However, such approach relies on the availability of packet-based data connection, which is not always available. In one approach, a voice-call approach may be used to facilitate tracking of activation of components, elements, and/or modules of the wireless device. In general, the wireless device may initiate a call to a remote activation server, where such call includes a message with activation data or information (or WSA event information) about one or more components, modules and/or elements of the wireless device. The remote activation server may tally the activation request (e.g., identify which component, module, and/or element is being activated) and may send an activation confirmation/acknowledgement (i.e. confirmation of receipt of WSA event information) to the wireless device. The activation message and/or confirmation may be secured by use of public/private key pairs and message authentication and/or integrity (e.g., using hash functions). Such keys and/or activation server information may be provisioned to, or collected by, the wireless device.

The remote activation capture described herein, may avoid having the service provider or communication carrier collect and report activation of the components, modules and/or elements to the manufacturer or vendors. Additionally, such remote activation capture allows for a business model where manufacturers or vendors of the components, modules, and/or elements (e.g., integrated hardware and/or software in the wireless device) collect fees and/or information related to the use of their corresponding components, modules, and/or elements. For example, the royalties may be based on which features in the hardware or software components are activated. Thus, the hardware or software components may include many features, which may or may not be activated all at once. The more features that are used by a wireless device, the higher the royalty for the corresponding component. Such fees (e.g., royalties) may occur after the wireless device has been deployed (e.g., after initial activation of the wireless device). Moreover, the information received from the wireless device about activation of one or more components, modules, and/or elements may be utilized for data mining. For example, such information may be useful to manufacturers of the wireless device or the modules, components, and/or elements in ascertaining how the wireless device is being used and which features are most/least popular or useful. Additionally, the activation message may include location information (e.g., from a GPS) for the wireless device, thereby indicating where the wireless devices, as well as the components, elements and/or modules, are being activated and providing a geographical distribution of users.

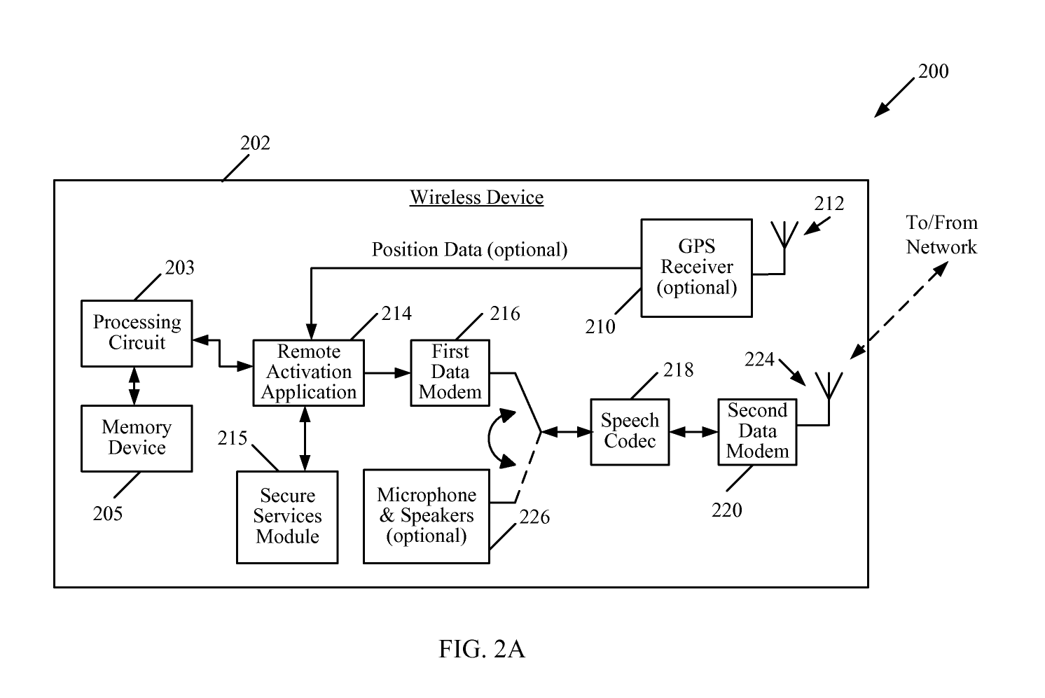

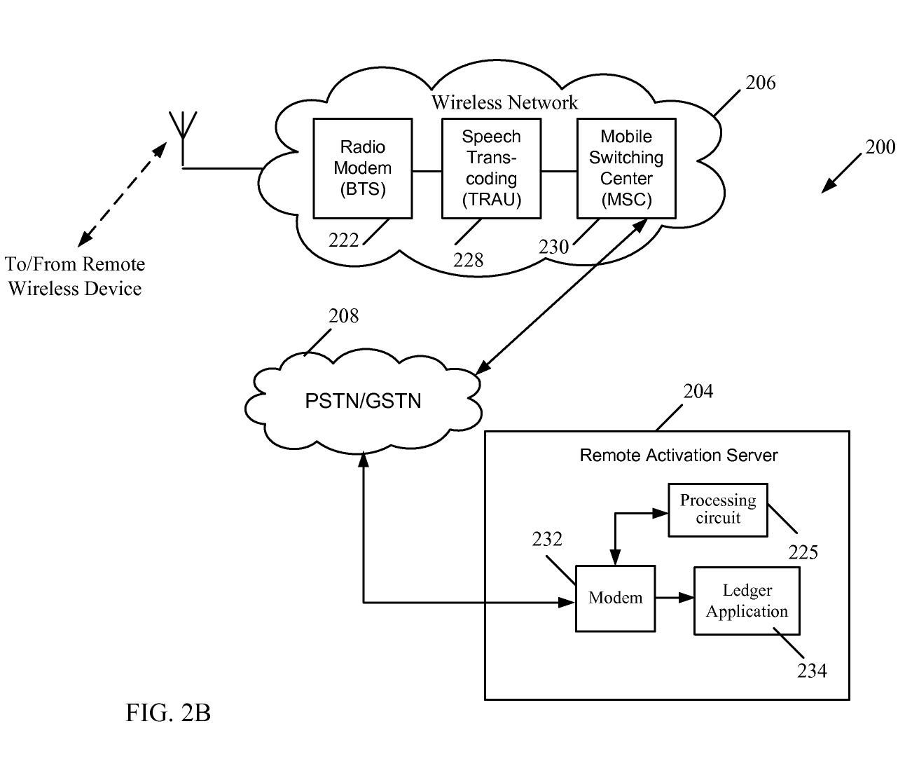

FIG. 2 (comprising FIGS. 2A and 2B) illustrates a functional block diagram of an activation capture system 200 according to one example. The activation capture system 200 may include a wireless device 202 which communicates with a remote activation server 204 via a wireless network 206 and/or a public switched telephone network (PSTN)/Global Switched Telephone Network (GSTN) 208. Various examples of a wireless device 202 include a mobile terminal, a mobile device, a personal digital assistant, a mobile phone, cell phone or lap top. The wireless device 202 may include a processing circuit (e.g., processor, processing module, etc) 203 and a memory device 205 to store activation data. Additional hardware and/or software components, modules, and/or elements may also be included in the wireless device 202.

According to one example, the wireless device 202 may be activated by a service provider or communication carrier to obtain communication service. Subsequent to such communication service activation, the wireless device 202 may be adapted to collect and/or report information about one or more hardware and/or software modules, components, and/or elements in the wireless device that have been activated. The wireless device 202 may initiate a call or message to a remote activation server 204 to report which components, elements, and/or modules have been activated. The remote activation server 204 may be a third party server different or separate from the service provider and not associated with the point of sale, which may be at a different location.

In one example, the initial reporting message or call may be through a mobile virtual network operator (MVNO). The MVNO may not be a company that provides mobile phone service but may not have its own licensed frequency allocation of radio spectrum, nor does it necessarily have the infrastructure required to provide mobile telephone service. MVNOs are roughly equivalent to the “switchless resellers” of the traditional landline telephone market. Switchless resellers buy minutes wholesale from the large long distance companies and retail them to their customers.

In some instances, a subscriber (e.g., an owner/user of wireless device) can be provided services by a particular network, such as a Mobile Virtual Network Operator (MVNO), and thus may be registered with a home agent that is assigned to the particular network. For example, MVNOs typically lease network infrastructure and utilize such infrastructure to provide services to subscribers associated with the MVNO. When a wireless device 202 powers On or initially enters a network (e.g., within range of a base station), an authentication/authorization/accounting (AAA) procedure is undertaken prior to enabling the wireless device 202 to access services associated with a network. To that end, the wireless device 202 can provide identifying indicia to a base station, which can in turn relay such indicia to an AAA or authentication server.

In one embodiment, such as a packet-data connection approach, the wireless device 202 may include a Global Positioning Satellite (GPS) receiver 210, coupled to an antenna 212, which may be utilized to generate location information or position data of the wireless device 202. The position data may be provided to a remote activation application 214, in communication with the processing circuit 203 and a secure services module 215, which may send the data to a first data modem 216 for transmission to a speech coder-decoder (CODEC) 218. The speech CODEC 218 may include an analog-to-digital converter (ADC) and a digital-to-analog converter (DAC), not shown. The speech CODEC 218 may receive input signals from the first data modem 216 and may output the signals to a radio (or voice-based data) modem or second data modem 220 which may be used to connect the wireless device 202 to a base transceiver station (BTS) or radio modem 222 in the wireless network 206 via an antenna 224.

The wireless device 202 may also include a microphone and speakers 226 the output of which are received by the speech CODEC 218 which in turn may then output signals to the radio (or voice-based data) modem or second data modem 220 which may be used to connect the wireless device 202 to the base transceiver station (BTS) or radio modem 222 in the wireless network 206.

According to one example, activation information for one or more modules, components, and/or elements may be reported by utilizing a voice-based data modem. Consequently, such activation information may be reported from “anywhere”, even when a packet-based data connection is not present. Furthermore, the use of the voice-based data modem may enhance security by obtaining a voice-based identification using voice data from the wireless device 202 within a short time of receiving the request for data from the wireless device 202. As a result of utilizing a voice-based data modem, data roaming limitations may be avoided and “toll-free” communications may be utilized. For instance, the wireless device 202 may be configured (either pre-configured from a manufacturer or upon activation of the wireless device by a service provider) with contact information (e.g., phone-number or network address, such as IP address, URL, or similar) for the remote activation server 204 which is used by the wireless device 202 to report which modules, components, and/or elements have been activated or used.

In one example, the BTS 222 may then send the signal to a Transcoder and Rate Adaption Unit (TRAU) 228 to raise and adapt the transmission rate of the bit flow arriving from the wireless device 202, via the BTS 222. From the TRAU 228, the data/signals may be sent to a mobile switching center (MSC) 230 which may provide the functions (additional routing services) required to switch calls to/from the wireless device 202 and a public switched telephone network (PSTN)/Global Switched Telephone Network (GSTN) 208.

From the PSTN/GSTN 208, the activation information provided by the wireless device 202 may be sent to the remote activation server 204 for facilitating capturing (or collecting) activation data for one or more components, elements and/or modules of the wireless device 202.

The remote activation server 204 may track activation or use of one more components, modules, and/or elements operating in, or integrated with, the wireless device 202. This information may be used, for example, to collect royalties by the manufactures/vendors of the one or more components, modules and/or elements when activated after the wireless device has been deployed. The remote activation server 204 may include a processing circuit 225 coupled to a data modem 232 and executing a ledger application 234 which may be used to store captured data (or WSA event information) relevant to the activation of one or more components of the wireless device 202. For example, relevant data may include the carrier selected by the wireless device 202, network utilized for activation, etc.

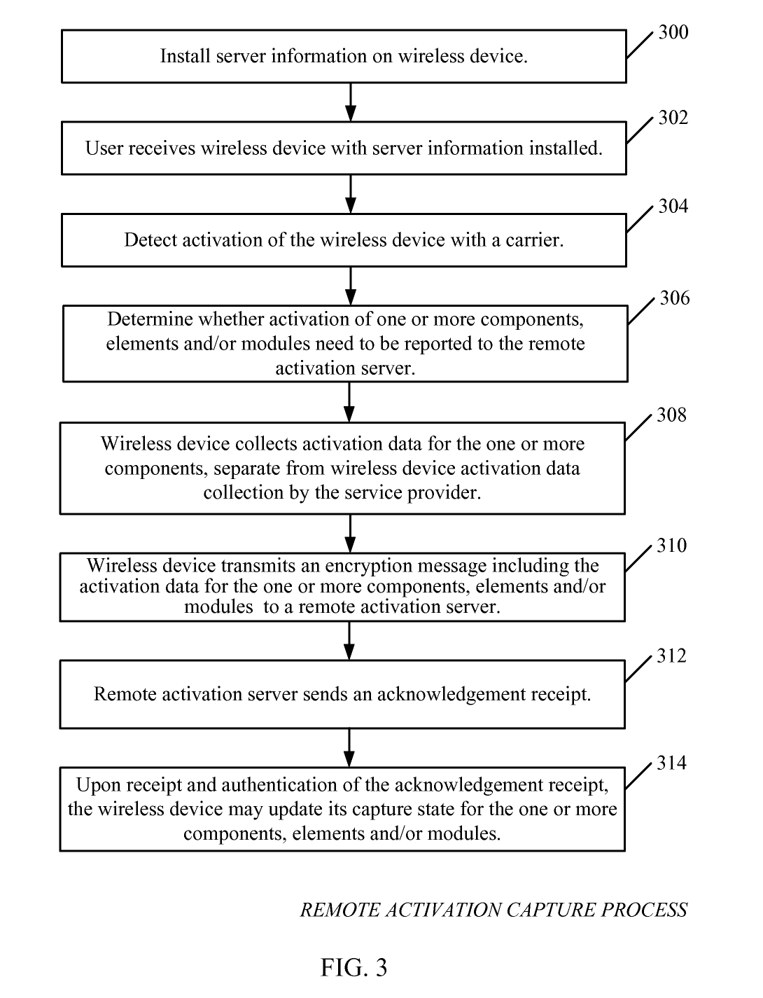

FIG. 3 illustrates a method for service activation of a wireless device (e.g., wireless communication device), according to one example. During the manufacturing process of the wireless device, server information may be installed on the wireless device 300. Server information may include a public key, identifier, and/or phone number for the wireless device. Once installed with the information, the wireless device may be shipped to a user. The user may receive the wireless device 302 and activate the wireless device with a carrier (or service provider). The wireless device may detect the activation with the carrier 304. Activation may occur using a carrier application, a Subscriber Identity Module (SIM), etc. Next, call management software (CM) in the wireless device may detect the activation and determine whether the activation of one or more components, elements and/or modules need to be reported to a remote activation server 306. The CM may be part of the system software or operating system of the wireless device. This may then trigger remote activation capture of one or more components, elements and/or modules in the wireless device, if not done, as well as due to policy criteria. Examples of such policy include re-activation for changes in service, as well as prevention of activation for particular types of service and/or activations past a reasonable period of time (e.g., expiration of activation capture).

Activation data (or WSA event information) may then be collected for one or more components, elements and/or modules of the wireless device, separate from wireless device activation data collection by the service provider 308. Next, the wireless device may transmit an encrypted message including the activation data (or WSA event information) for the one or more components elements and/or modules to a remote activation server 310. Such transmission may occur, for example, by the wireless device dialing a server phone number installed in the wireless device during manufacturing.

Upon receipt of the activation information (or WSA event information) for the one or more components elements and/or modules, the remote activation server may authenticate the activation request. Though the wireless device may not yet be subscribed to any services, a wireless device ID is associated with the wireless device. The wireless device ID may be used in subsequent communications between the activation server and the wireless device to facilitate subscriptions or for identification of the wireless device. The activation server may respond by sending an authenticated activation receipt or acknowledgement to the wireless device 312. Upon receipt and authentication of the acknowledgement receipt, the wireless device may update its capture state for the one or more components elements and/or modules 314.

Authentication may occur by utilizing public-key cryptography so that messages transactions may be mutually authenticated. In one aspect, an RSA encryption algorithm may be utilized. In one aspect, a SHA-1 hash algorithm may be utilized for the signature.

By mutually authenticating transactions, fraud may be avoided as there may be secure/signed confirmation that the client is authentic as well as secure confirmation that the server is authentic. In public key-private key cryptography, asymmetric key algorithms are used, i.e. the key used to encrypt a message is not the same as the key used to decrypt it. Each user has a pair of cryptographic keys—a public key and a private key. The private key is kept secret, while the public key may be widely distributed. Messages are encrypted with the recipient's public key and can only be decrypted with the corresponding private key. The keys are related mathematically, but the private key cannot be feasibly (i.e., in actual or projected practice) derived from the public key. Furthermore, transactions using key information may be unique to the client or wireless device. As described above, each wireless device may include a unique device serial number which may be the mobile equipment identifier (MEID) or the international mobile equipment identity/identification (IMEI). By utilizing unique identification for each device, the flow of activations vs. shipments may be tracked and double-counting may be avoided.

Furthermore, by utilizing the systems and method described herein, non-repudiation, i.e. ensuring that a party in a dispute cannot repudiate, or refute the validity of a statement or contract, may occur. In others words, information that the transaction was real may be confirmed by authenticating the transaction using a unique identifier (ID).

### Exemplary Wireless Device

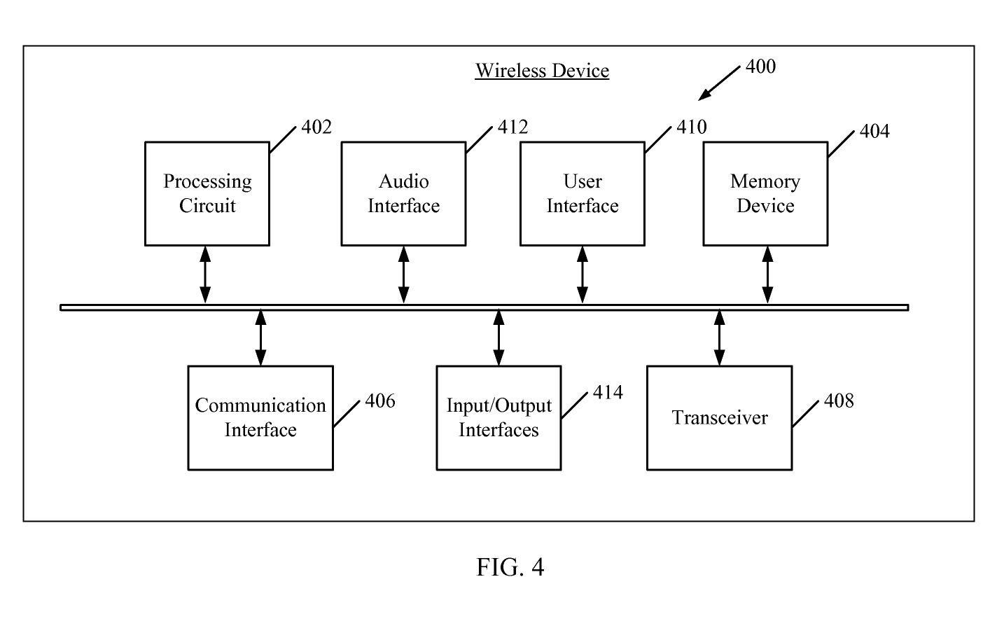

FIG. 4 illustrates a block diagram of an internal structure of a wireless device 400 of an activation capture system according to one example. As described above, the wireless device 400 may communicate with a remote activation server via a wireless network and/or a public switched telephone network (PSTN)/Global Switched Telephone Network (GSTN).

The wireless device 400 may include a processing circuit (e.g., processor, processing module, etc) 402 for executing computer-executable process steps and a memory device 404 to store activation data. The wireless device 400 may also include a communication interface 406 for communicatively coupling the wireless device 400 to an access point. The wireless device 400 may also include a transceiver 408 for collecting and reporting activation (or use) information for one or more components, modules, and/or elements of the wireless device 400. The wireless device 400 may also include a user interface 410, an audio interface 412 and input/output interfaces 414.

To authenticate a message, signature authentication may be used. When using signature authentication, the message may first be hashed. In one example of sending a secure message from a wireless device to a remote activation server, a wireless device hashes a message. When hashing the message, a one-way hash function, such as SHA-1 (Secure Hash Algorithm) may be used. The SHA-1 hash algorithm may be used for integrity checking.

The hash may then be scrambled using the wireless device's private key, i.e., the hashed message may be encrypted using the sender's private key. Next, the message and scrambled hash may be scrambled with the server's public key and sent to the server. Upon receipt, the server may unscramble the secure message with the server's private key and unscramble the hash with the wireless device's public key, i.e., the encrypted hash may then be decrypted with the sender's public key. The hash may then be checked to authenticate the message and sender. To ensure message integrity, messages may be verified by re-hashing and comparing the signature to the hash.

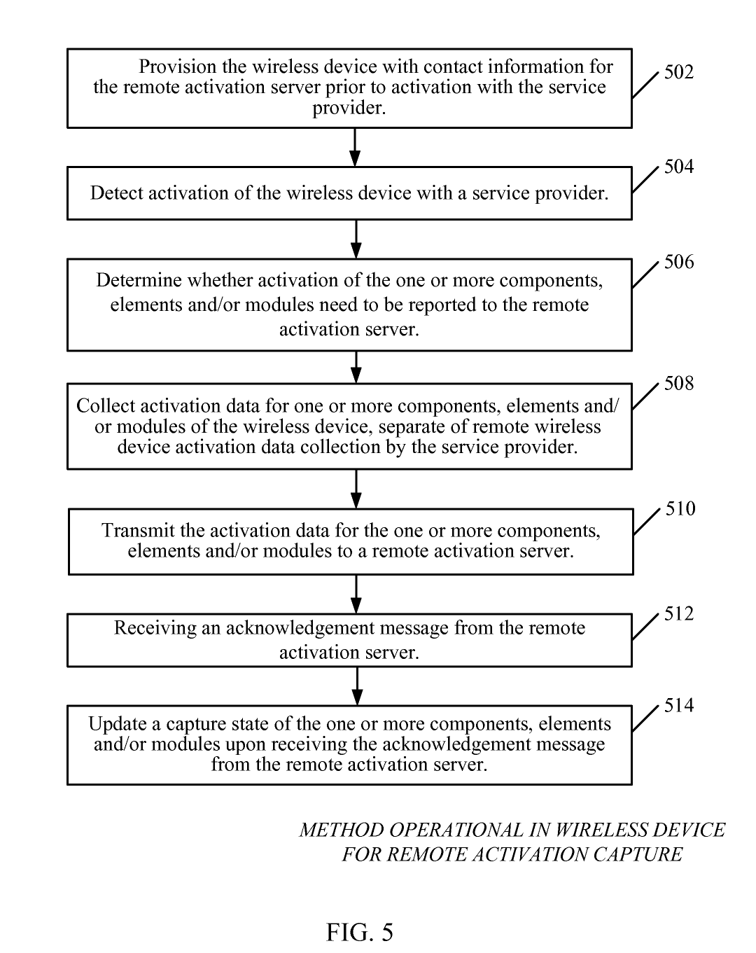

FIG. 5 illustrates an example of the operation of the wireless device. The wireless device may be provisioned with contact information for the remote activation server prior to activation with the service provider 502. Activation of the wireless device with a service provider may then be detected 504. A determination may be made as to whether the activation (e.g., use) of the one or more components, elements and/or modules need to be reported to the remote activation server 506. Activation data or information may then be collected for one or more components, elements and/or modules of the wireless device, separate from wireless device activation data collection by the service provider 508. At least one of the one or more components, elements and/or modules identified by the activation data (or WSA event information) may include at least one of: a modem, a transmitter, a receiver, or a radio transceiver.

The activation data (or WSA event information) for the one or more components, elements and/or modules may then be transmitted to a remote activation server 510. The activation data may include a unique identifier associated with the wireless device. The activation data (or WSA event information) may also include a unique identifier associated with the service provider. The remote activation server may be independent of the service provider. An acknowledgement message may be received from the remote activation server 512. A capture state of the one or more components may be updated upon receiving the acknowledgement message from the remote activation server 514.

In one example, the reporting of activation data between the wireless device and the remote activation server may be secured by cryptographic keys. For instance, a private/public key pair may be generated by the wireless device, where the public key can be used to decrypt data encrypted with the private key. The transmission of the activation data may then be secured using the private key.

According to another feature, location information may be obtained for the wireless device. This location information may be included as part of the activation data.

### Exemplary Remote Activation Server

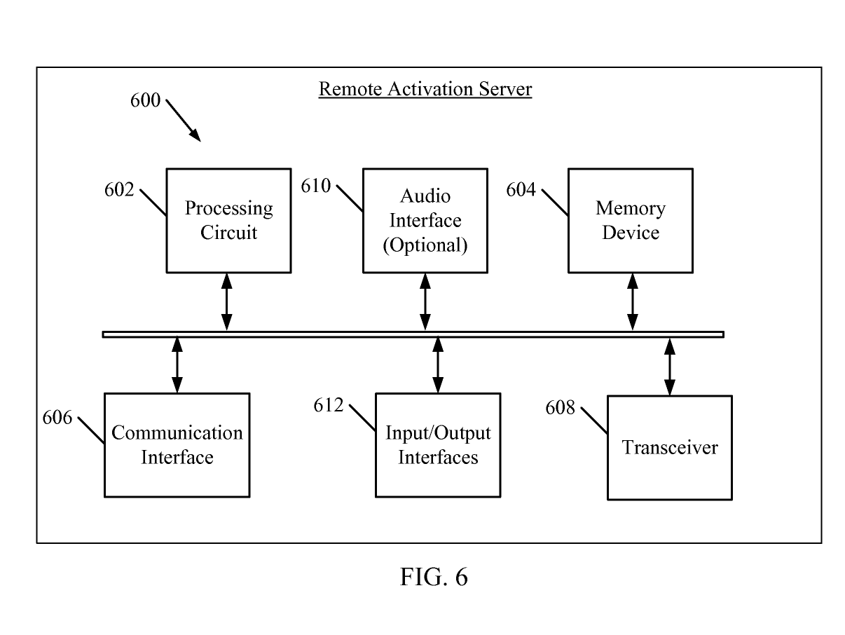

FIG. 6 illustrates a block diagram of an internal structure of a remote activation server 600 of an activation capture system according to one example. As described above, the remote activation server 600 may communicate with a wireless device via a wireless network and/or a public switched telephone network (PSTN)/Global Switched Telephone Network (GSTN).

The remote activation server 600 may include a processing circuit (e.g., processor, processing module, etc) 602 for executing computer-executable process steps and a memory device 604 to store activation data. The remote activation server 600 may also include a communication interface 606 for communicatively coupling the remote activation server 600 to an access point. The remote activation server 600 may also include a transceiver 608 for collecting and receiving activation (or use) information for one or more components, modules, and/or elements of wireless devices. The remote activation server 600 may also include an audio interface 610 and input/output interfaces 612.

According to one example, a remote activation server may include: a memory device, a transceiver, and a processing circuit (among other components, modules, and/or elements). The transceiver may be coupled to the memory device and provides connectivity to one or more wireless devices. The processing circuit may be coupled to the memory device and the transceiver and may be adapted to collect activation information from one or more wireless devices, where such activation information is indicative of the activation (e.g., use) information for one or more components, modules, and/or elements of the wireless device.

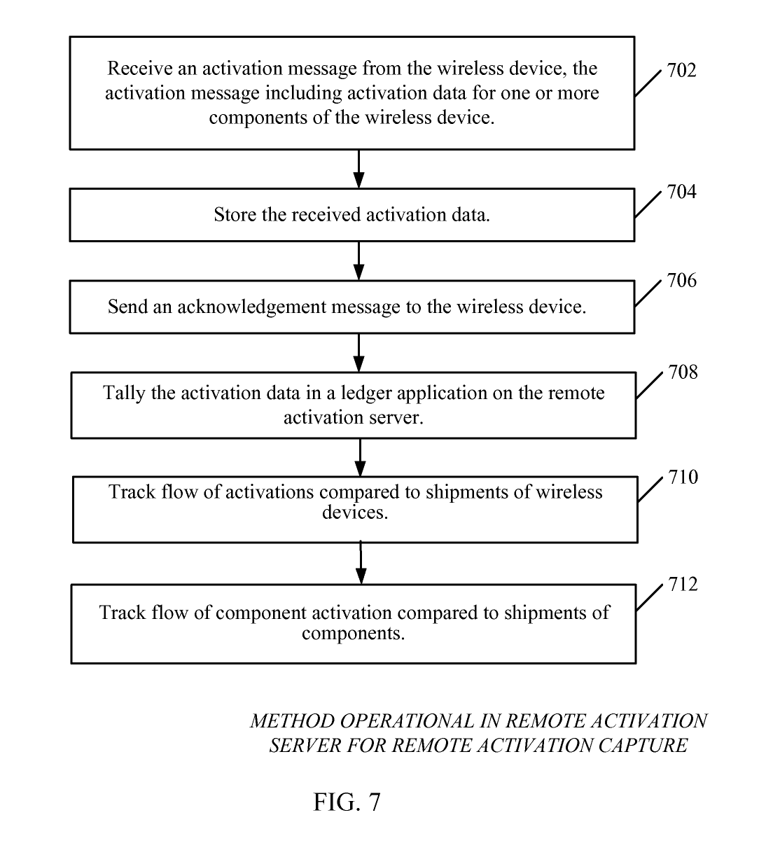

FIG. 7 illustrates an example of the operation of the remote activation server. An activation message may be received from a wireless device, where the activation message includes activation data (or WSA event information) for one or more components, elements and/or modules of the wireless device 702. Note that the activation message may be independent and separate from a service provider activation of the wireless device.

The received activation data (or WSA event information) may be stored 704 and an acknowledgement message may be sent to the wireless device 706. The activation data (or WSA event information) for the one or more components, elements and/or modules may include a unique identifier for the wireless device. The activation data (or WSA event information) for the one or more components, elements and/or modules may also include a unique identifier for each of the one or more components, elements and/or modules. In one implementation, the activation data (or WSA event information) may permit collection of fees associated with the activation of the one or more components, elements and/or modules. The fees may also be collected prior to use of the components, elements and/or modules

The activation data may be tallied in a ledger application on the remote activation server 708. In one example, the activation data may include a unique identifier for the wireless device, and the flow of activations may be tracked in comparison to shipments of wireless devices 710. In another example, the activation data (or WSA event information) includes one or more unique identifiers associated with the one or more components, and the flow of component, element and/or module activations may be tracked in comparison to shipments of components 712.

### Exemplary Remote Activation System Operation

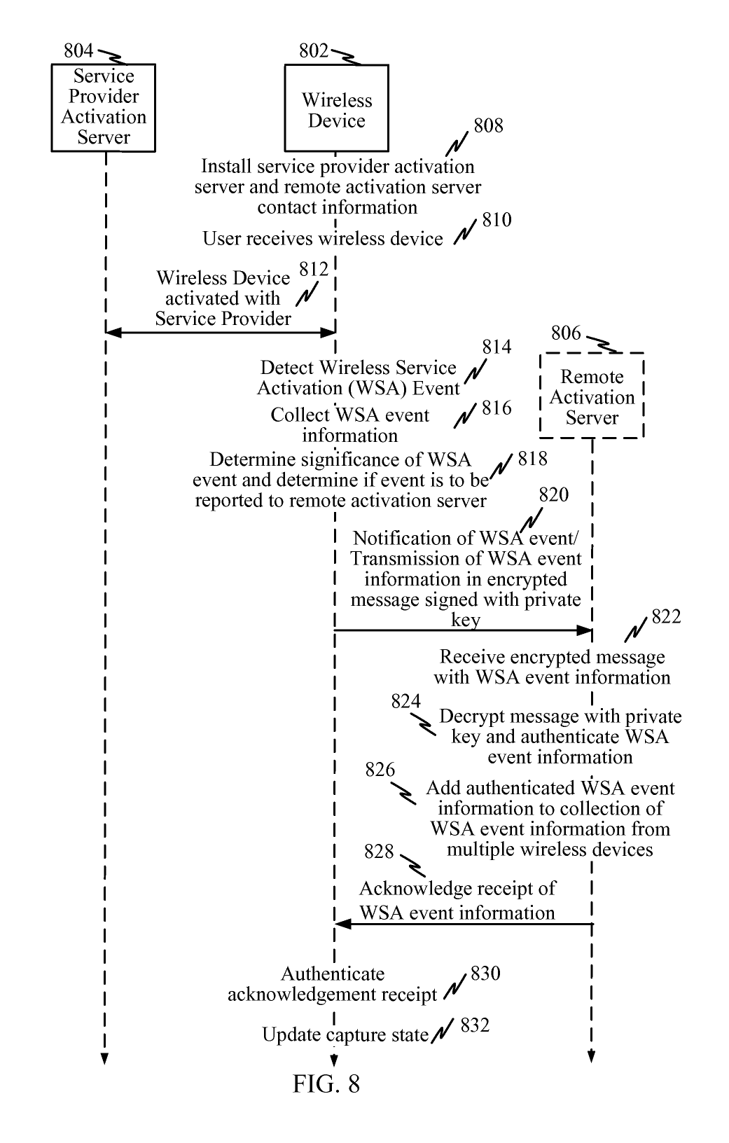

FIG. 8 is a flow diagram illustrating the operation of a wireless communication system in which the collection of information about the activation of components, modules, and/or elements of a wireless device 802 is separate from wireless device activation data collection by a service provider activation server 804. This example illustrates one possible implementation of a remote activation server 806 collecting information related to the activation of components, modules, and/or elements of multiple wireless devices in one or more service provider networks

During the manufacturing process, the wireless device may be installed with information related to the server provider, including the service provider activation server, and the remote activation server 808. This information may include, but is not limited to, a public key, identifier, and/or phone number for the wireless device so that the wireless device manufacturer can track and/or collect payment for such subsequent activations of additional capabilities and/or features. Additionally, the wireless device may be configured with contact information (e.g., phone-number or network address, such as IP address, URL, or similar) for the remote activation server which, as described above, may be used by the wireless device to report which modules, components, and/or elements have been activated or used. Additionally, the wireless device may be programmed with call management software (CM) to detect and securely communication wireless service activation (WSA) events.

Once installed with the information, the wireless device may be shipped to a user. After receiving the wireless device 810, the user may then activate the wireless device with a service provider (or carrier) via the service provider activation server providing communication services to the user 812. Activation may occur using a carrier application, a Subscriber Identity Module (SIM), etc.

After the wireless device has been activated, the call management software (CM) in the wireless device may detect any wireless service activation (WSA) events that occur 814. WSA events may include, but are not limited to, the activation of any components, elements and/or modules on the wireless device. The wireless device may collect WSA event information (or activation data), such as payment for such subsequent activations of additional capabilities and/or features 816.

Once a WSA event has been detected, the wireless device may determine the significance of the WSA event and determine if the WSA event is to be reported to the remote activation server 818. If it is determined that the WSA event is to be reported to the remote activation server, an appropriate communication means for communicating the event may be determined, and a mutually-authenticated secure transaction with the remote activation server may be performed. For instance, if a user seeks to activate certain communication capabilities of the wireless device that were not included in the original activation of the wireless device, then at the occurrence of such triggering or WSA event, the wireless device may notify the remote activation server that such capabilities are being activated by transmitting the WSA event information (or activation data) in an encrypted message signed with a private key 820. Such transmission may occur, for example, by the wireless device dialing a server phone number installed in the wireless device during manufacturing. Such remote activation server may be owned, for example, by the wireless device manufacturer, thereby allowing the wireless device manufacturer to directly track and/or collect payment for such subsequent activations of additional capabilities and/or features.

Upon receipt of the encrypted message with the WSA event information, i.e. information related to the activation of one or more components elements and/or modules 822, the remote activation server may decrypt the message using its private key and then authenticate the decrypted WSA event information (or activation data) 824.

All the WSA event information (or activation data) received from wireless devices about activation of one or more components, modules, and/or elements may be collected by the remote activation server and may be utilized for data mining 826. For example, as described above, such information may be useful to manufacturers of the wireless device or the modules, components, and/or elements in ascertaining how the wireless device is being used and which features are most/least popular or useful. Additionally, the activation message may include location information (e.g., from a GPS) for the wireless device, thereby indicating where the wireless devices, as well as the components, elements and/or modules, are being activated and providing a geographical distribution of users.

After adding the authenticated WSA event information (or activation data) to its collection of WSA event information (or activation data) from multiple wireless devices 826, the remote activation server may respond by sending an authenticated activation receipt or acknowledgement to the wireless device 828. Upon receipt and authentication of the acknowledgement receipt 830, the wireless device may update its capture state for the one or more components elements and/or modules 832.

### Tracking Activation of Components

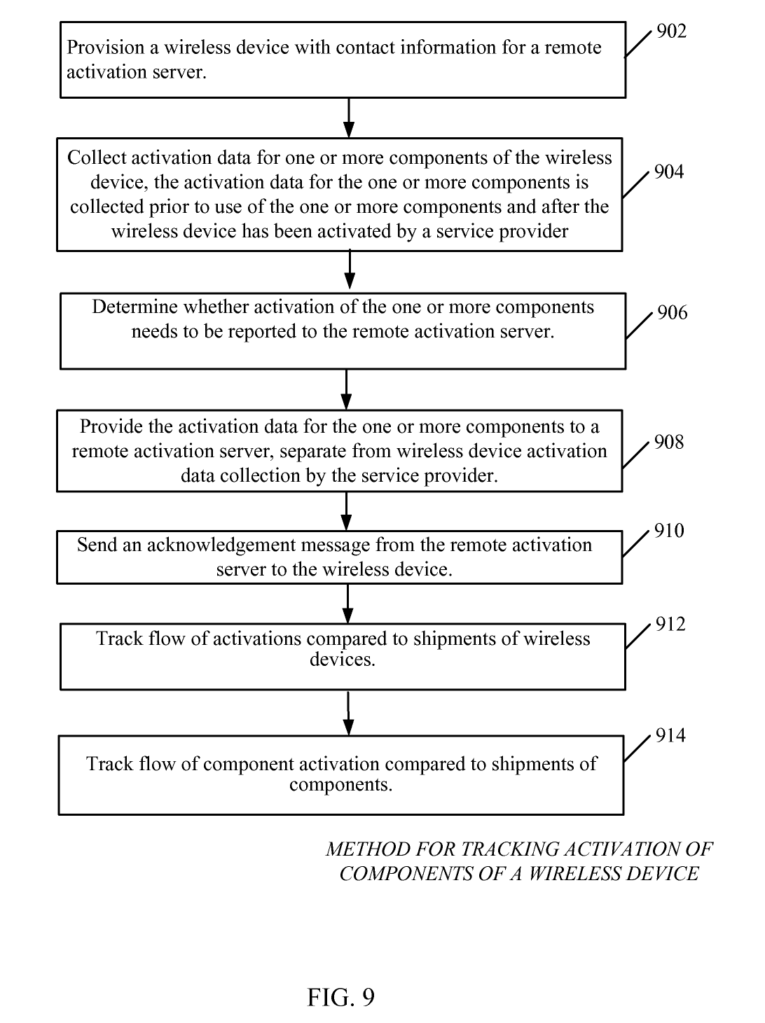

FIG. 9 illustrates an example of a method for tracking activation of components of a wireless device. First, during the manufacturing process, the wireless device may be installed or provisioned with information related to the remote activation server 902. This information may include, but is not limited to, contact information (e.g., phone-number or network address, such as IP address, URL, or similar) for the remote activation server which, as described above, may be used by the wireless device to report which modules, components, and/or elements have been activated or used.

Once installed with the contact information, activation data (or WSA event information) may be collected for one or more components of the wireless device that have been activated. The activation data may be collected prior to use of the one or more modules, components and/or elements 904. After collection of the data, the wireless device may determine whether the activation data of the one or more modules, components and/or elements needs to be reported to the remote activation server 906. If it is determined that the activation data is to be reported to the remote activation server, the wireless device may then provide the activation data for the one or more modules, components and/or elements to the remote activation server, separate from wireless device activation data collection by the service provider 908.

Upon receipt of the activation data, the remote activation server may provide an acknowledgement message to the wireless device 910. In one example, the activation data may include a unique identifier for the wireless device, and the flow of activations may be tracked in comparison to shipments of wireless devices 912. In another example, the activation data (or WSA event information) includes one or more unique identifiers associated with the one or more components, and the flow of component, element and/or module activations may be tracked in comparison to shipments of components 914. A royalty may be paid in relation to the number of the one or more components that are identified as activated by the activation data

It should be recognized that, generally, most of the processing described in this disclosure may be implemented in a similar fashion. Any of the circuit(s) or circuit sections may be implemented alone or in combination as part of an integrated circuit with one or more processors. The one or more of the circuits may be implemented on an integrated circuit, an Advance RISC Machine (ARM) processor, a digital signal processor (DSP), a general purpose processor, etc.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Moreover, a storage medium may represent one or more devices for storing data, including read-only memory (ROM), random access memory (RAM), magnetic disk storage mediums, optical storage mediums, flash memory devices and/or other machine or computer readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

One or more of the components, steps, and/or functions illustrated in the Figures may be rearranged and/or combined into a single component, step, or function or embodied in several components, steps, or functions. Additional elements, components, steps, and/or functions may also be added without departing from the invention. The apparatus, devices, and/or components illustrated in the Figures may be configured to perform one or more of the methods, features, or steps described in the Figures. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features described herein can be implemented in different systems without departing from the invention.

It should be noted that the foregoing embodiments are merely examples and are not to be construed as limiting. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method operational on a wireless device for capturing activation of one or more components of the wireless device, comprising:
detecting activation of the wireless device with a service provider;
subsequently collecting activation data for one or more components of the wireless device; and
transmitting the activation data for the one or more components to a remote activation server, separate from wireless device activation data collection by the service provider.

2. The method of claim 1, further comprising:
receiving an acknowledgement message from the remote activation server.

3. The method of claim 2, further comprising:
updating a capture state of the one or more components upon receiving the acknowledgement message from the remote activation server.

4. The method of claim 1, further comprising:
determining whether activation of the one or more components has not been reported to the remote activation server.

5. The method of claim 1, further comprising:
provisioning the wireless device with contact information for the remote activation server prior to activation with the service provider.

6. The method of claim 1, wherein the remote activation server is independent of the service provider.

7. The method of claim 1, wherein the activation data includes a unique identifier associated with the wireless device.

8. The method of claim 1, wherein the activation data includes a unique identifier associated with the service provider.

9. The method of claim 1, further comprising:
generating a private/public key pair, where the private key can be used to decrypt data encrypted with the public key; and
signing the transmission of the activation data using the private key.

10. The method of claim 1, further comprising:
obtaining location information for the wireless device; and
including the location information as part of the activation data.

11. The method of claim 1, wherein a voice-based data modem is used to transmit the activation data.

12. The method of claim 1, wherein at least one of the one or more components identified by the activation data includes at least one of: a modem, a transmitter, a receiver, or a radio transceiver.

13. The method of claim 1, wherein the activation data for the one or more components is collected prior to use of the one or more components.

14. A wireless device, comprising:
a memory device;
a transceiver coupled to the memory device, the transceiver for providing connectivity to a remote activation server; and
a processing circuit coupled to the memory device and the transceiver, the processing circuit configured to:
detect activation of the wireless device with a service provider;
subsequently collect activation data for one or more components of the wireless device; and
transmit the activation data for the one or more components to a remote activation server, separate from wireless device activation data collection by the service provider.

15. The wireless device of claim 14, wherein the processing circuit is further configured to:
receive an acknowledgement message from the remote activation server; and
update a capture state of the one or more components upon receiving the acknowledgement message from the remote activation server.

16. The wireless device of claim 14, further comprising:
a Global Positioning Satellite (GPS) receiver adapted to obtain location information for the wireless device; and
wherein the processing circuit is further configured to include the location information as part of the activation data.

17. The wireless device of claim 14, wherein the processing circuit is further configured to:
determine whether activation of the one or more components needs to be reported to the remote activation server.

18. The wireless device of claim 14, wherein the wireless device is provisioned with contact information for the remote activation server prior to activation with the service provider.

19. The wireless device of claim 14, wherein the activation data includes a unique identifier associated with the wireless device.

20. The wireless device of claim 14, wherein the activation data includes one or more identifiers associated with the one or more components of the wireless device.

21. The wireless device of claim 14, wherein at least one of the one or more components identified by the activation data includes at least one of: a modem, a transmitter, a receiver, or a radio transceiver.

22. The wireless device of claim 14, wherein the activation data for the one or more components is collected prior to use of the one or more components.

23. A wireless device, comprising:
means for detecting activation of the wireless device with a service provider;
means for subsequently collecting activation data for one or more components of the wireless device; and
means for transmitting the activation data for the one or more components to a remote activation server, separate from wireless device activation data collection by the service provider.

24. The wireless device of claim 23, further comprising:
means for receiving an acknowledgement message from the remote activation server; and
means for updating a capture state of the one or more components upon receiving the acknowledgement message from the remote activation server.

25. The wireless device of claim 23, further comprising:
means for obtaining location information for the wireless device; and
wherein the location information is part of the activation data.

26. The wireless device of claim 23, further comprising:
means for determining whether activation of the one or more components need to be reported to the remote activation server.

27. A computer-readable medium comprising instructions for capturing activation of one or more components of a wireless device, which when executed by a processor causes the processor to:
detect activation of the wireless device with a service provider;
subsequently collect activation data for one or more components of the wireless device; and
transmit the activation data for the one or more components to a remote activation server, separate from wireless device activation data collection by the service provider.

28. The computer-readable medium of claim 27, further comprising instructions which when executed by a processor causes the processor to:
receive an acknowledgement message from the remote activation server; and
update a capture state of the one or more components upon receiving the acknowledgement message from the remote activation server.

29. The computer-readable medium of claim 27, further comprising instructions which when executed by a processor causes the processor to:
determine whether activation of the one or more components need to be reported to the remote activation server.

30. A method operational on a remote activation server for capturing activation of one or more components of a wireless device, comprising:
receiving an activation message from the wireless device, the activation message including activation data for one or more components of the wireless device;
storing the received activation data; and
sending an acknowledgement message to the wireless device.

31. The method of claim 30, wherein the activation message is independent of a service provider activation of the wireless device.

32. The method of claim 30, wherein the activation data for the one or more components includes a unique identifier for the wireless device.

33. The method of claim 30, wherein the activation data for the one or more components includes a unique identifier for each of the one or more components.

34. The method of claim 30, wherein the activation data permits collection of fees associated with the activation of the one or more components.

35. The method of claim 30, further comprising:
tallying the activation data in a ledger application on the remote activation server.

36. The method of claim 30, wherein the activation data includes a unique identifier for the wireless device, and further comprising:
tracking flow of activations compared to shipments of wireless devices.

37. The method of claim 30, wherein the activation data includes one or more unique identifiers associated with the one or more components, and further comprising:
tracking flow of component activations compared to shipments of components.

38. A remote activation server, comprising:
a memory device;
a transceiver coupled to the memory device, the transceiver for providing connectivity to one or more wireless devices; and
a processing circuit coupled to the memory device and the transceiver, the processing circuit configured to:
receive an activation message from a wireless device, the activation message including activation data for one or more components of the wireless device;
store the received activation data in the memory device; and
send an acknowledgement message to the wireless device.

39. The remote activation server of claim 38, wherein the activation message is independent of a service provider activation of the wireless device.

40. The remote activation server of claim 38, wherein the activation data for the one or more components includes a unique identifier for the wireless device.

41. The remote activation server of claim 38, wherein the activation data for the one or more components includes a unique identifier for each of the one or more components.

42. The remote activation server of claim 38, wherein the activation data includes a unique identifier for the wireless device, and the processing circuit further configured to:
track flow of activations compared to shipments of wireless devices.

43. The remote activation server of claim 38, wherein the activation data includes one or more unique identifiers associated with the one or more components, and the processing circuit further configured to:
track flow of component activations compared to shipments of components.

44. A remote activation server, comprising:
means for receiving an activation message from a wireless device, the activation message including activation data for one or more components of the wireless device;
means for storing the received activation data; and
means for sending an acknowledgement message to the wireless device.

45. A computer-readable medium comprising instructions operational on a remote activation server for capturing activation of one or more components of a wireless device, which when executed by a processor causes the processor to:
receive an activation message from the wireless device, the activation message including activation data for one or more components of the wireless device;
store the received activation data; and
send an acknowledgement message to the wireless device.

46. A method for tracking activation of components of a wireless device, comprising:
collecting activation data for one or more components of the wireless device, the activation data for the one or more components is collected prior to use of the one or more components and after the wireless device has been activated by a service provider;
providing the activation data for the one or more components to a remote activation server, separate from wireless device activation data collection by the service provider; and
tracking component activations compared to shipments of components.

47. The method of claim 46, further comprising:
sending an acknowledgement message from the remote activation server to the wireless device; and
updating a capture state of the one or more components at the wireless device upon receiving the acknowledgement message from the remote activation server.

48. The method of claim 46, further comprising:
determining whether activation of the one or more components needs to be reported to the remote activation server.

49. The method of claim 46, further comprising:
provisioning the wireless device with contact information for the remote activation server prior to activation with the service provider.

50. The method of claim 46, wherein the remote activation server is independent of the service provider.

51. The method of claim 46, further comprising:
paying a royalty in relation to the number of the one or more components that are identified as activated by the activation data.
